(19) United States
(12) Patent Application Publication
(10) Pub. No.: US 2015/0301731 A1
(43) Pub. Date: Oct. 22, 2015

(54) USER INTERFACE APPARATUS

(71) Applicants: Natsumi OKAMOTO, Tokyo (JP); Hiroki KONAKA, Tokyo (JP); Syogo YONEYAMA, (US)

(72) Inventors: Natsumi OKAMOTO, Tokyo (JP); Hiroki KONAKA, Tokyo (JP); Syogo YONEYAMA, Tokyo (JP)

(73) Assignee: MITSUBISHI ELECTRIC CORPORATION, Tokyo (JP)

(21) Appl. No.: 14/436,429

(22) PCT Filed: Nov. 15, 2012
(86) PCT No.: PCT/JP2012/079625

§ 371 Date: Apr. 16, 2015

(51) Int. Cl. G06F 3/0484; G06T 13/80

(52) U.S. Cl. CPC G06F 3/04847; G06F 3/04842; G06T 13/80

(57) ABSTRACT

It is an object to provide a technique which enables shortening of design time and facilitation of a design work for implementing a display of a state transition animation. A user interface apparatus includes an event processing storage which stores a state transition of display state and an event processing being associated with each other and processing circuitry which executes an event processing in accordance with an input operation received by a receiver and also executes, on a display, a state transition associated with the event processing to be executed. In a case of executing the state transition, the execution unit creates an animation display component which defines a display state using a state transition animation, and on the way of the state transition, executes the animation display component, to thereby display the state transition animation on the display.

### TECHNICAL FIELD

The present invention relates to a user interface apparatus, and more particularly to a user interface apparatus using a receiver and a display.

### BACKGROUND ART

As a technique for displaying a screen on a display device (display) of a user interface apparatus, well known is a technique using a basic display component which is pre-designed as a component (UI component) for screen display and a composite display component which is formed by combination of the basic display component and the like.

In this technique, for each of a plurality of display states which are pre-assigned to a higher-level composite display component, at least either one display component of a basic display component and a composite display component are defined and associated with an event processing in accordance with an input operation of a user, to thereby change a display state. By the technique accompanied with such a state transition, a display of screen can be changed to a display state suitable for an event processing. Patent Document 1 discloses a technique for performing a state transition of a display state.

### PRIOR-ART DOCUMENTS

### Patent Documents

[Patent Document 1] Japanese Patent Application Laid Open Gazette No. 07-129375

### SUMMARY OF INVENTION

### Problems to be Solved by the Invention

In the above-described user interface apparatus, a change from a display state before a state transition to another display state after the state transition is performed instantaneously. In contrast to this, it is thought preferable to display an animation on the way of the state transition in terms of upscale image and entertainment of the user interface apparatus.

In order to display such an animation, however, it is necessary to design a plurality of display states (for example, still images or the like) to be displayed chronologically, and this arises a problem of needing a longer design time as a whole. Moreover, in most design works of display state, coding is performed by engineers and there is a problem that this is a hard work for graphic designers who have little knowledge of programming.

Then, the present invention is intended to solve the above problems, and it is an object of the present invention to provide a technique which enables time reduction and facilitation of a design work for implementing a display of a state transition animation.

### Means for Solving the Problems

The present invention is intended for a user interface apparatus using a receiver and a display. According to the present invention, the user interface apparatus includes a state-specific display component storage which stores a state-specific display component including at least either one display component of a basic display component pre-designed as a component for screen display and a composite display component formed to include the basic display component, for each display state. The user interface apparatus also includes an event processing storage which stores a state transition from a display state by one state-specific display component to a display state by another state-specific display component and an event processing the state transition and the event processing, the state transition and the event processing being associated with each other, and a processing circuitry which executes the event processing in accordance with an input operation received by the receiver and also executes, on the display, the state transition associated with the event processing to be executed. In a case of executing the state transition, the processing circuitry creates an animation display component which defines a display state by a state transition animation using the display state of the state-specific display component, and on the way of the state transition, executes the animation display component, to thereby display the state transition animation on the display. In a case of not executing the state transition, the processing circuitry displays the display state of the state-specific display components used by the state transition animation on the display.

### Effects of the Invention

According to the present invention, the user interface apparatus can automatically create and display an animation display component to be executed on the way of a state transition. Therefore, it is possible to achieve time reduction and facilitation of a design work for implementing a display of a state transition animation.

### BRIEF DESCRIPTION OF DRAWINGS

FIG. 1 is a block diagram showing a constitution of a user interface apparatus in accordance with a first preferred embodiment;

FIG. 2 is a view showing an exemplary relation between a basic display component and a composite display component;

FIGS. 3A and 3B are views showing an exemplary state transition of display state;

FIG. 4 is a view showing information stored in a state-specific display storage in accordance with the first preferred embodiment;

FIG. 5 is a view showing information stored in an event processing storage in accordance with the first preferred embodiment;

FIG. 6 is a flowchart showing an operation of the user interface apparatus in accordance with the first preferred embodiment;

FIGS. 7A to 7E are views showing an exemplary display on a display in accordance with the first preferred embodiment;

FIG. 8 is a view showing an operation of an execution unit in accordance with the first preferred embodiment;

FIG. 9 is a view showing another operation of the execution unit in accordance with the first preferred embodiment;

FIG. 10 is a block diagram showing a constitution of a user interface apparatus in accordance with a second preferred embodiment;

FIG. 11 is a view showing a composite display component in accordance with the second preferred embodiment;

FIG. 12 is a view showing a composite display component in accordance with a first variation of the second preferred embodiment;

FIG. 13 is a view showing a composite display component in accordance with a second variation of the second preferred embodiment; and

FIG. 14 is a view showing a composite display component in accordance with a third variation of the second preferred embodiment.

### DESCRIPTION OF EMBODIMENTS

### the First Preferred Embodiment

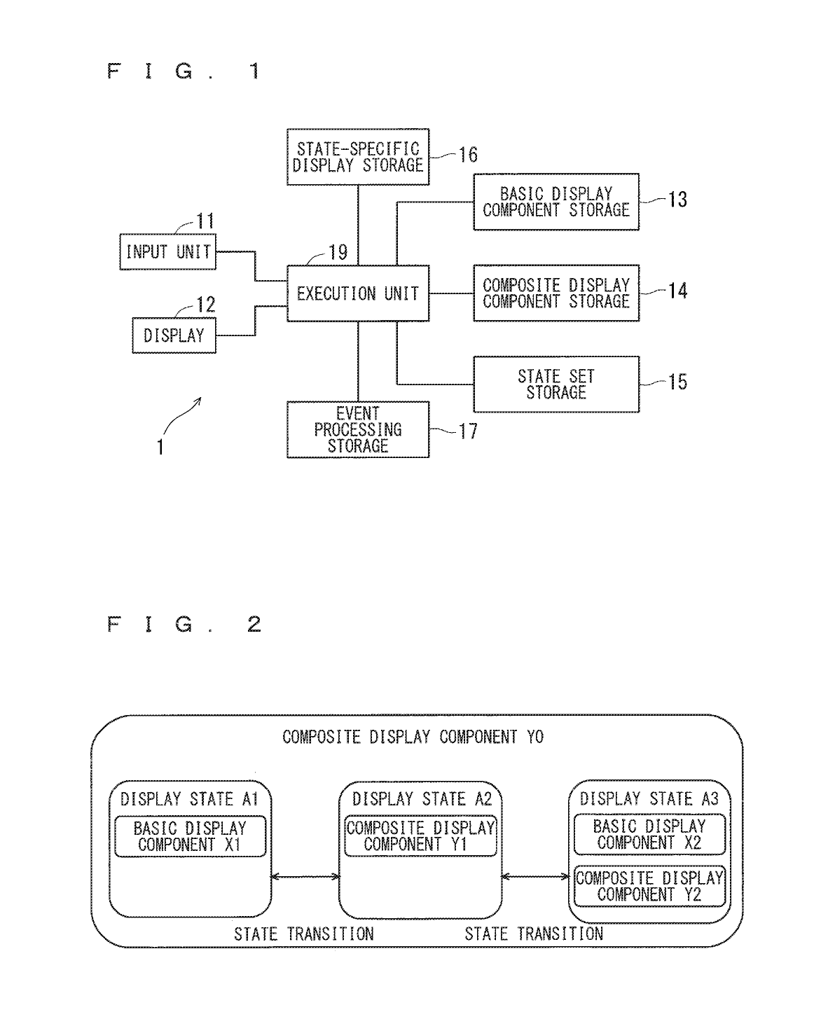

FIG. 1 is a block diagram showing a constitution of a user interface apparatus 1 in accordance with the first preferred embodiment of the present invention. The user interface apparatus 1 is a user interface apparatus using an input unit (receiver) and a display. Though discussion will be made hereinafter on a user interface apparatus 1 included in a navigation device such as a car navigation device, a PND (Portable Navigation Device), a portable terminal (for example, a cellular phone, a smartphone, and a tablet), and the like, the present invention is not limited to this type but the user interface apparatus 1 may be included in any device which uses an input unit and a display and has a user interface function.

The user interface apparatus 1 comprises an input unit 11, a display 12, a basic display component storage 13, a composite display component storage 14, a state set storage 15, a state-specific display storage (a state-specific display component storage) 16, an event processing storage 17, and an execution unit 19 which performs an overall control of these constituent elements.

The input unit 11 is an input device such as a push-button device which receives a manipulation of a user as an input operation, a voice recognition device which receives a voice of a user as the input operation, or the like. The display 12 is a display device such as a liquid crystal display or the like. The input unit 11 and the display 12 may be formed of individual hardwares, respectively, or of a hardware constructed as a unit (such as a display device with touch panel).

The basic display component storage 13, the composite display component storage 14, the state set storage 15, the state-specific display storage 16, and the event processing storage 17 are formed of a storage device such as a HDD (Hard Disk Drive), a semiconductor memory, or the like. The execution unit 19 is a processor such as a CPU (Central Processing Unit) or the like. Although an example of the execution unit 19 that is implemented by the CPU as the software has been described above, the execution unit 19 of the software may be substituted by an electric circuit of the hardware with respect to a function of the execution unit 19. The execution unit 19 of the software and the execution unit 19 of the hardware are collectively referred to as processing circuitry.

Next, among the above-described constituent elements included in the user interface apparatus 1, the basic display component storage 13, the composite display component storage 14, the state set storage 15, the state-specific display storage 16, the event processing storage 17, and the execution unit 19 will be described in detail.

The basic display component storage 13 stores a basic display component which is pre-designed as a component (UI component) for screen display. The composite display component storage 14 stores a composite display component which is formed to include a basic display component.

FIG. 2 is a view showing an exemplary relation between the basic display component and the composite display component. In an exemplary case of FIG. 2, shown is a higher-level composite display component Y0 to which a plurality of display states (herein, three display states A1, A2, and A3) are assigned. Each of these display states A1, A2, and A3 is provided with at least either one display component of a lower-level basic display component and a lower-level composite display component. Specifically, the display state A1 is defined by a lower-level basic display component X1 and a layout (display position and display range). Similarly, the display state A2 is defined by a lower-level composite display component Y1 and a layout. The display state A3 is defined by a lower-level basic display component X2, a lower-level composite display component Y2 and a layout.

Though detailed description will be made later, the execution unit 19 executes an event processing in accordance with an input operation received by the input unit 11 and also executes a state transition (for example, a state transition from the display state A1 to the display state A2) corresponding to the event processing on the display 12.

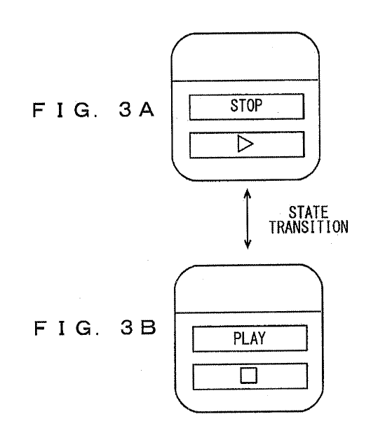

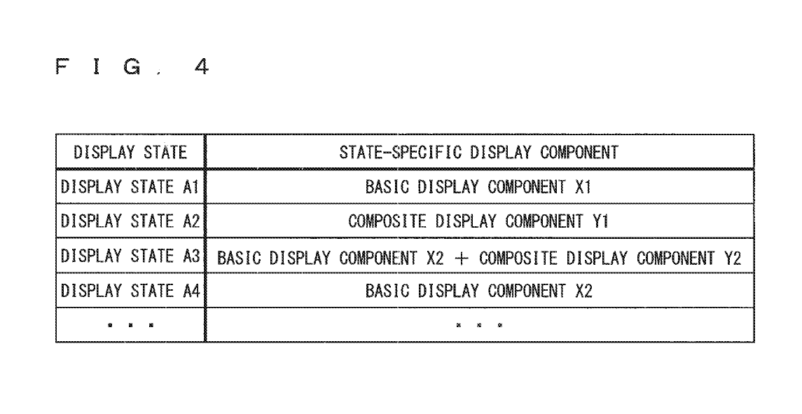

FIGS. 3A and B are views showing an exemplary state transition of display state. In an exemplary case of FIGS. 3A and B, with execution of the event processing in accordance with the input operation, the display on the display 12 is changed from a display state (FIG. 3A) to another display state (FIG. 3B) suitable for the event processing.

Referring back to FIG. 1, the state set storage 15 stores a set of display states (for example, the above-described display states A1, A2, and A3).

The state-specific display storage 16 stores a state-specific display component including at least either one display component of a basic display component and a composite display component, for each display state, as shown in FIG. 4. The display states A1, A2, and A3 in FIG. 4 correspond to the display states A1, A2, and A3 in FIG. 2, respectively, and when a state-specific display component (the basic display component X1) which defines the display state A1 is executed, for example, the corresponding display state A1 is displayed on the display 12.

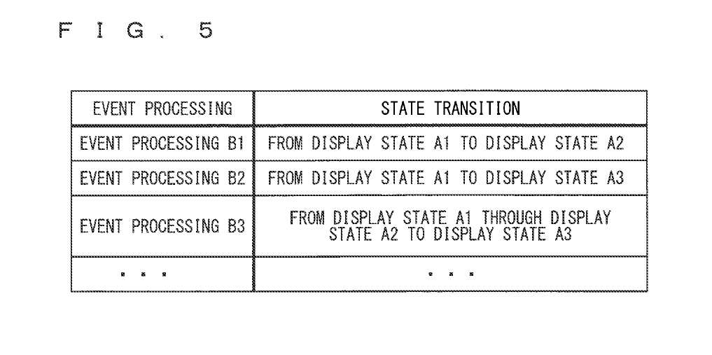

The event processing storage 17 (FIG. 1) stores a state transition from a display state by one state-specific display component to a display state by another state-specific display component and an event processing, being associated with each other, as shown in FIG. 5. The display states A1, A2, and A3 in FIG. 5 correspond to the display states A1, A2, and A3 in FIGS. 2 and 4, respectively.

As described above briefly, the execution unit 19 executes an event processing in accordance with the input operation received by the input unit 11 and also executes a state transition associated with the event processing to be executed, on the display 12. In a case where respective correspondences between the state transitions and the event processings shown in FIG. 5 are stored in the event processing storage 17, for example, when the execution unit 19 executes the event processing B1, the state transition from the display state A1 to the display state A2, which is associated with the event processing B1, is executed. In other words, the display of the display 12 is changed from the display state A1 displayed by execution of the state-specific display component (basic display component X1) to the display state A2 to be displayed by execution of the state-specific display component (composite display component Y1).

When the execution unit 19 executes the state transition, the execution unit 19 creates an animation display component which defines a display state using a state transition animation. Then, on the way of the state transition, the execution unit 19 executes the animation display component which is created, to thereby display the state transition animation on the display 12. The creating and displaying operations will be described next in detail, with reference to a flowchart.

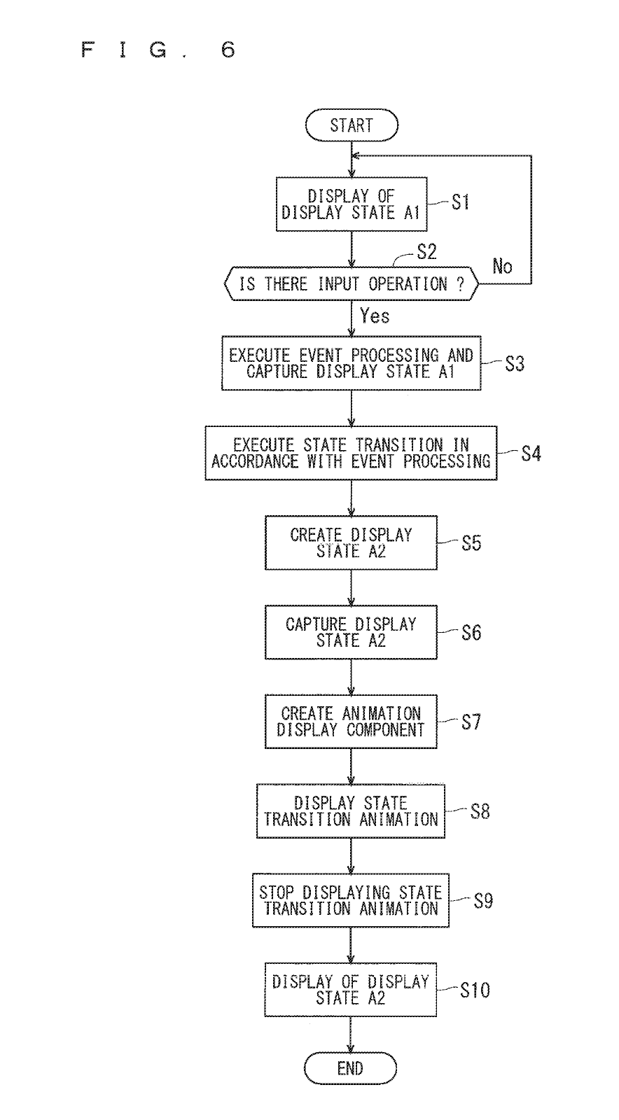

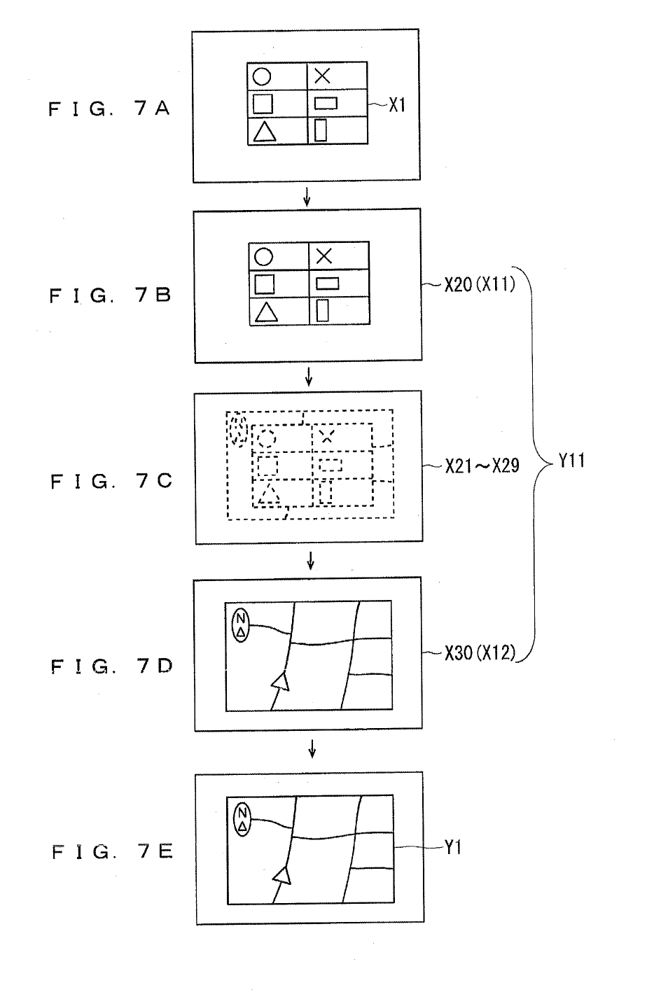

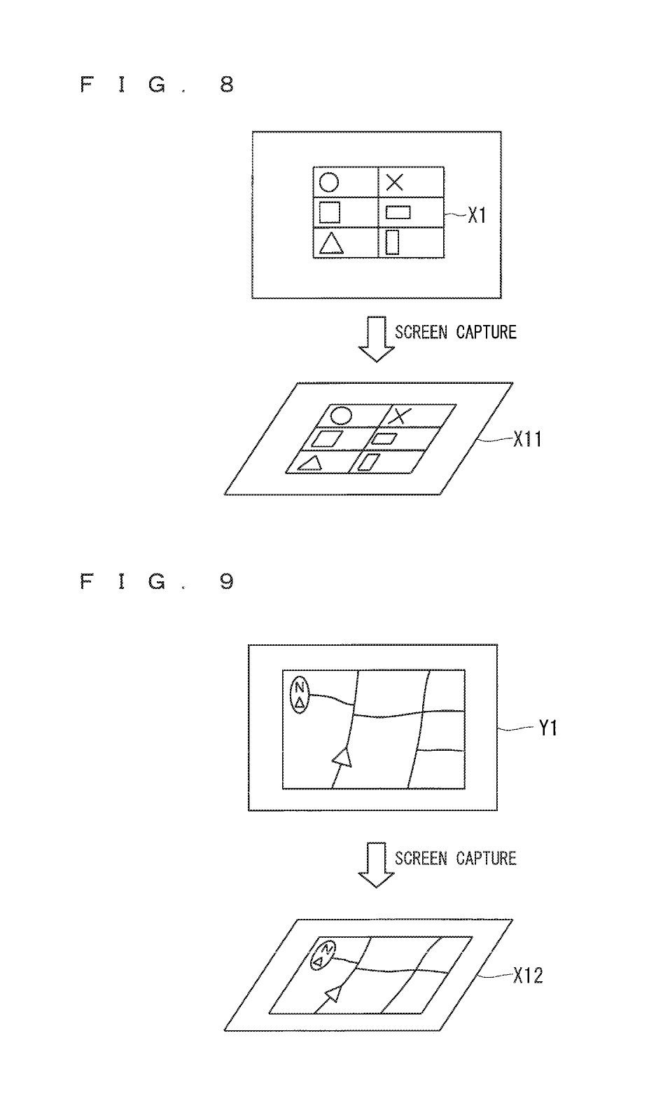

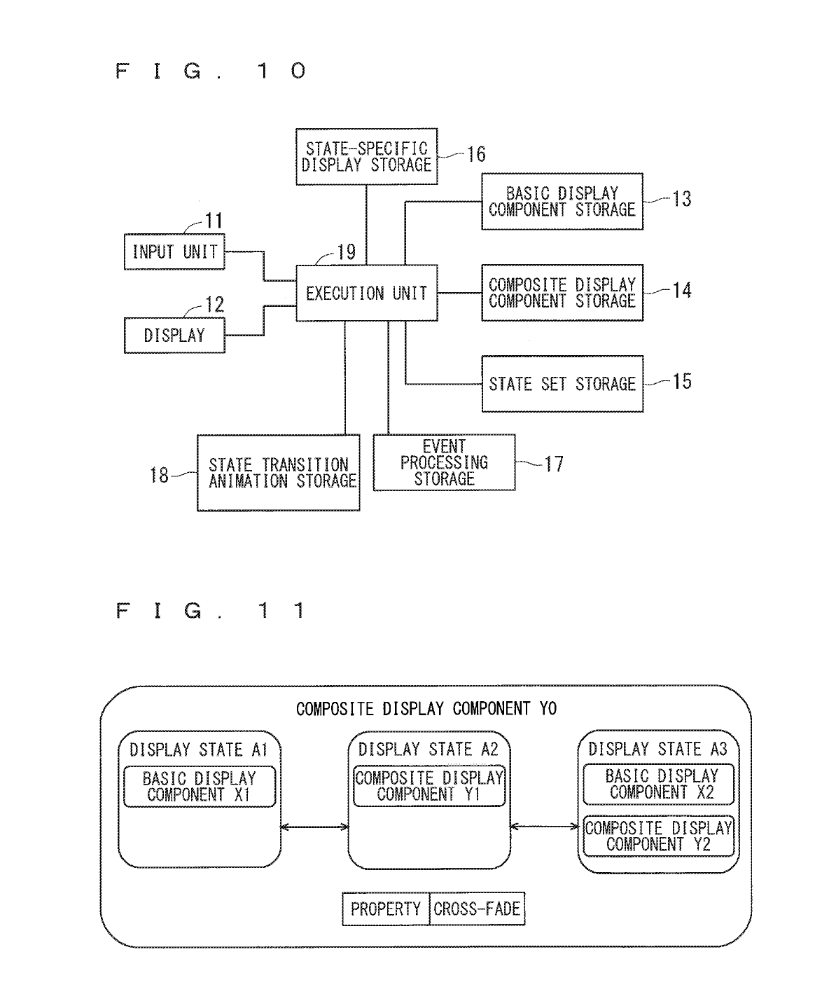

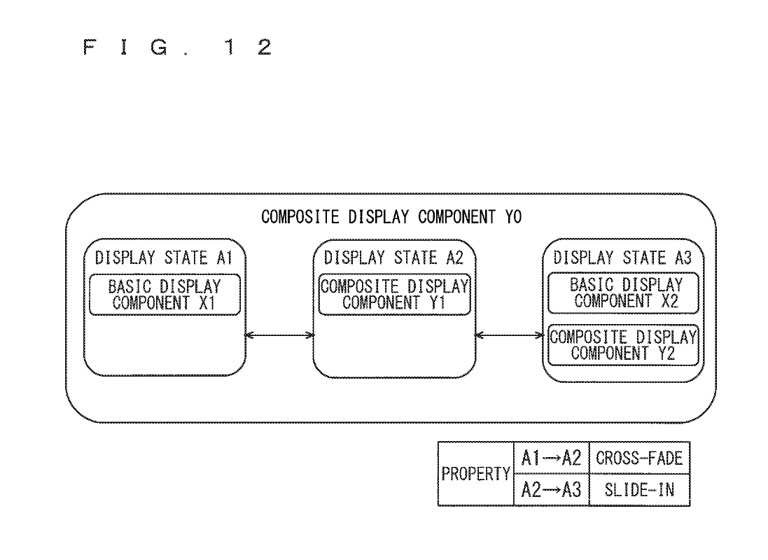

FIG. 6 is a flowchart showing an operation of the user interface apparatus 1 in accordance with the first preferred embodiment, FIGS. 7A to 7E are views showing an exemplary display of the display 12 accompanying the operation, and FIGS. 8 and 9 are views each showing the creation of the animation display component by the execution unit 19. A series of operations shown in FIG. 6 are performed when the execution unit 19 executes a program stored in the above-described storage device.

Next, with reference to FIGS. 6 to 9, description will be made on an operation of the user interface apparatus 1.

Herein, on the assumption that the information shown in FIG. 4 is stored in the state-specific display storage 16 and the information shown in FIG. 5 is stored in the event processing storage 17, description will be made on an exemplary case where the display 12 displays the display state A1 in Step S1 as shown in FIG. 7A. The operations in Steps S2 to S7 are performed as a part of computation inside the execution unit 19, and until the state transition animation is displayed by the animation display component in Step S8, the display 12 displays the display state A1 shown in FIG. 7A.

In Step S2, the execution unit 19 determines whether or not the input unit 11 receives an input operation. When the execution unit 19 determines that the input unit 11 receives an input operation, the process goes to Step S3, and when the execution unit 19 does not determine that the input unit 11 receives an input operation, the process goes back to Step S1.

In Step S3, the execution unit 19 executes an event processing in accordance with the input operation received in Step S2. The execution unit 19 also creates a basic display component corresponding to the display state before the state transition. As shown in FIG. 8, for example, the execution unit 19 captures a screen (PreScreen) in the display state A1 before the state transition, which is displayed on the display 12, and creates a basic display component X11 indicating the screen.

Referring back to FIG. 6, in Step S4, the execution unit 19 executes the state transition associated with the event processing executed in Step S3. When the event processing B1 is executed in Step S3, for example, the execution unit 19 executes the state transition from the display state A1 to the display state A2, which is associated with the event processing B1 in the event processing storage 17.

In Step S5, the execution unit 19 creates a display state after the state transition in Step S4. When the state transition from the display state A1 to the display state A2 is executed in Step S4, for example, the execution unit 19 creates the display state A2 as data without displaying the display state on the display 12, on the basis of the composite display component Y1 which defines the display state A2.

In Step S6, the execution unit 19 creates a basic display component corresponding to the display state after the state transition. As shown in FIG. 9, for example, the execution unit 19 captures a screen (PostScreen, not displayed on the display 12 yet at this stage) in the display state A2 after the state transition, which is created in Step S5, and creates a basic display component X12 indicating the screen.

In Step S7, the execution unit 19 creates a composite display component including the basic display components created in Steps S3 and S6, as the above-described animation display component.

Herein, description will be made on an exemplary case where the execution unit 19 creates a composite display component Y11 including the basic display components X11 and X12 shown in FIGS. 8 and 9, respectively, as the animation display component. The execution unit 19 creates a composite image by superimposing an image with a transmittance of t % shown in FIG. 8, which is defined by the basic display component X11, and another image with a transmittance of (100−t) % shown in FIG. 9, which is defined by the basic display component X12, and further creates a basic display component for displaying the composite image. The execution unit 19 performs the creation of the basic display components for, e.g., t=0, 10, 20, . . . , and 100.

Then, the execution unit 19 creates the composite display component Y11 to be used for displaying a basic display component X20 created when t=0, a basic display component X21 created when t=10, . . . , and a basic display component X30 created when t=100 in this order, as an animation display component Y11. The basic display component X20 is substantially the same as the basic display component X11, and the basic display component X30 is substantially the same as the basic display component X12.

In Step S8, the execution unit 19 executes the animation display component created in Step S7, to thereby display the state transition animation on the display 12. When the execution unit 19 executes the animation display component Y11 including the basic display components X20 to X30, for example, a state transition first occurs where the display state of the display 12 is changed from the display state A1 shown in FIG. 7A, which is defined by the basic display component X1, to a display state shown in FIG. 7B, which is defined by the basic display component X20.

Then, the state transitions sequentially occur where the display state of the display 12 is changed from the display state shown in FIG. 7B, which is defined by the basic display component X20, to display states shown in FIG. 7C, which are defined by the basic display components X21, X22, . . . , and X29, and further to a display state shown in FIG. 7D, which is defined by the basic display component X30.

After that, in Step S9, the execution unit 19 acquires an end event of an animation by the animation display component. When the execution unit 19 displays the display state defined by the basic display component X30 on the display 12, for example, the execution unit 19 acquires an end event of the animation by the animation display component Y11. When the execution unit 19 acquires the end event, the process goes to Step S10.

In Step S10, the execution unit 19 displays the display state after the state transition on the display 12. When the execution unit 19 displays the display state defined by the basic display component X30 on the display 12 and acquires the end event, for example, the execution unit 19 displays the display state A2 defined by the composite display component Y1 on the display 12, as shown in FIG. 7E.

Thus, the user interface apparatus 1 in accordance with the first preferred embodiment automatically creates the animation display component to be executed on the way of the state transition and displays the animation. Therefore, it is possible to shorten the time required for the design work for implementing the display of the state transition animation and also possible to facilitate the design work.

Further, the user interface apparatus 1 in accordance with the first preferred embodiment creates an animation display component including basic display components (for example, basic display components X11 and X12) corresponding to the display states before and after the state transition. Therefore, it is possible to achieve the display of state transition animation having continuity with the display states before and after the state transition.

In the above description, the case has been described where the cross-fade in which one screen (the display state defined by the basic display component X11 in the above exemplary case) fades out and another screen (the display state defined by the basic display component X12 in the above exemplary case) fades in is applied to an animation pattern of the state transition animation.

If the animation display component, however, includes a basic display component (the basic display components X21 to X29 in the above example) corresponding to a display state obtained by changing at least one of arrangement, shape, size, and color (brightness or contrast) of the display state before or after the state transition, the animation pattern is not limited to the above cross-fade.

The animation pattern may be any one of, for example, a “slide-in” in which one screen is fixed and another screen is moved onto the one screen and displayed, a “slide-out” in which one screen is moved away and another screen which has been fixed below the one screen is displayed, a “fade-out/in” in which one screen is displayed before a white screen or a black screen is displayed, then another screen is displayed, a “zoom-in/zoom-out” in which one screen is enlarged or reduced and another screen which is fixed below the one screen is displayed, and a “roll” in which one screen is rotated and another screen which is fixed below the one screen is displayed.

In the first preferred embodiment, description has been made on the assumption that the program to be executed by the execution unit 19 prescribes that any one of the plurality of kinds of animation patterns described above is always used. The present invention is not limited to this, but the user interface apparatus 1 may be configured so that a combination of a plurality of kinds of animation patterns may be used, as described later in the second preferred embodiment.

Further, if it is not necessary to perform a display having the above-described continuity, the animation display component may not include the basic display components (the basic display components X11 and X12 in the above exemplary case) corresponding to the display states before and after the state transition but may include only one basic display component which enables a display of, for example, only black screen.

Furthermore, the capture described in Steps S3 and S6 may not be performed on a screen basis, but may be performed, for example, on a layout basis.

### The Second Preferred Embodiment

In the second preferred embodiment of the present invention, a plurality of animation patterns are prepared, and an animation display component can be created by using a specified animation pattern among these animation patterns. Hereinafter, description will be made on such a user interface apparatus in accordance with the second preferred embodiment.

FIG. 10 is a block diagram showing a constitution of a user interface apparatus 1 in accordance with the second preferred embodiment. In the user interface apparatus 1 in accordance with the second preferred embodiment, constituent elements identical or similar to those described in the first preferred embodiment are represented by the same reference signs, and hereinafter, description will be centered on the characterized feature different from that of the first preferred embodiment.

As shown in FIG. 10, the constitution of the user interface apparatus 1 in accordance with the second preferred embodiment is the same as that of the user interface apparatus 1 in accordance with the first preferred embodiment shown in FIG. 1, except that a state transition animation storage 18 is additionally provided. The state transition animation storage 18 is formed of the above-described storage device like the basic display component storage 13 and the like.

The state transition animation storage 18 stores an animation pattern (for example, the above-described cross-fade, slide-in, and the like) applicable to an animation display component.

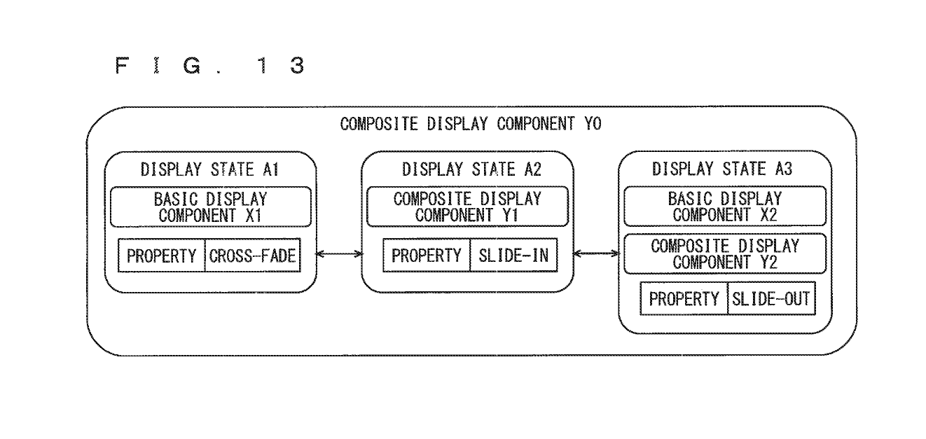

FIG. 11 is a view showing an exemplary composite display component in accordance with the second preferred embodiment.

A property for setting characteristics and attributes of the composite display component Y0 includes properties (additional information) for setting characteristics and attributes of the state transition (A1 to A2) and the state transition (A2 to A3). Herein, the state transition from the display state A1 to the display state A2 is represented as “state transition (A1 to A2)” and the state transition from the display state A2 to the display state A3 is represented as “state transition (A2 to A3)”, and the same representation applies to the following.

In an exemplary case of FIG. 11, the property of the composite display component Y0 including the properties of the state transition (A1 to A2) and the state transition (A2 to A3) includes specifying information for specifying one animation pattern (herein, cross-fade) common to the state transitions.

In such a constitution, when the execution unit 19 executes the state transition (A1 to A2), the execution unit 19 acquires one animation pattern (cross-fade) specified by the specifying information included in the property of the composite display component Y0 (the specifying information included in the property of the state transition (A1 to A2)) from the state transition animation storage 18.

Then, the execution unit 19 creates an animation display component to be executed on the way of the state transition (A1 to A2), on the basis of the acquired one animation pattern (cross-fade). In other words, the execution unit 19 creates the animation display component which enables a display of state transition animation by the cross-fade on the way of the state transition (A1 to A2).

Further, in a case of executing the state transition (A2 to A3), like in the case of executing the state transition (A1 to A2), the execution unit 19 creates an animation display component which enables a display of state transition animation by the cross-fade on the way of the state transition (A2 to A3).

Thus, the user interface apparatus 1 in accordance with the second preferred embodiment creates a plurality of animation display components to be executed on the way of each of the plurality of state transitions, on the basis of one animation pattern common to the plurality of state transitions. Therefore, it is possible to use a desired animation pattern collectively and also possible to facilitate the design work required for implementing a display using the animation pattern.

<The First Variation of the Second Preferred Embodiment>

FIG. 12 is a view showing an exemplary composite display component in accordance with a first variation of the second preferred embodiment. In the first variation, the property of each state transition (each state transition shown on the right side of FIG. 5) includes specifying information for specifying an animation pattern specific to the state transition. FIG. 12 shows an exemplary case, and the property of the state transition (A1 to A2) includes the specifying information for specifying the cross-fade as the animation pattern and the property of the state transition (A2 to A3) includes the specifying information for specifying the slide-in as the animation pattern.

In such a constitution, when the execution unit 19 executes the state transition (A1 to A2), the execution unit 19 acquires the animation pattern (cross-fade) specified by the specifying information included in the property of the state transition (A1 to A2) from the state transition animation storage 18. Then, the execution unit 19 creates an animation display component to be executed on the way of the state transition (A1 to A2), on the basis of the acquired animation pattern (cross-fade).

Similarly, when the execution unit 19 executes the state transition (A2 to A3), the execution unit 19 acquires the animation pattern (slide-in) specified by the specifying information included in the property of the state transition (A2 to A3) from the state transition animation storage 18. Then, the execution unit 19 creates an animation display component to be executed on the way of the state transition (A2 to A3), on the basis of the acquired animation pattern (slide-in).

Thus, the user interface apparatus 1 in accordance with the first variation creates an animation display component to be executed on the way of each state transition, on the basis of the animation pattern specific to the state transition. Therefore, it is possible to achieve a display using the animation pattern suitable for each state transition.

Further, also in a case where the state transition (A1 to A2) is executed in a composite display component other than the composite display component Y0, an animation display component to be executed on the way of the state transition (A1 to A2) may be created on the basis of the same animation pattern (the cross-fade in the above exemplary case) as that for the state transition (A1 to A2) in the composite display component Y0.

<The Second Variation of the Second Preferred Embodiment>

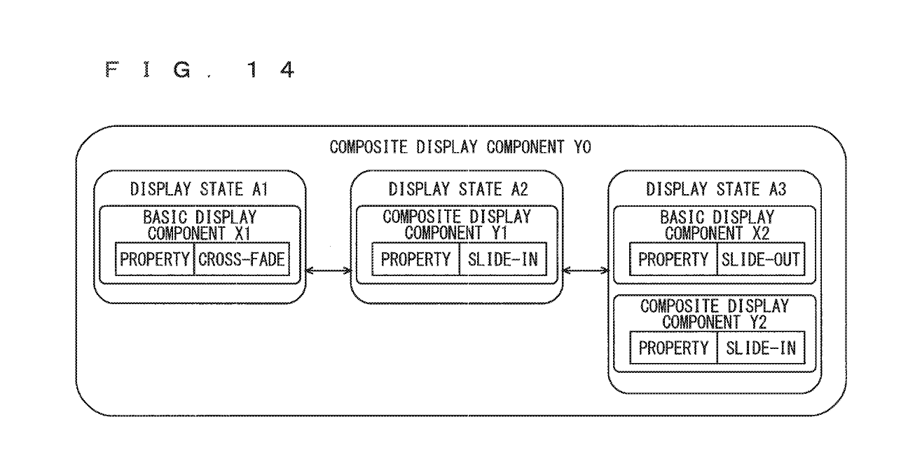

FIG. 13 is a view showing an exemplary composite display component in accordance with a second variation of the second preferred embodiment. In the second variation, the property of each display state (each display state shown on the left side of FIG. 4) includes specifying information for specifying an animation pattern specific to the display state. FIG. 13 shows an exemplary case, and the properties of the display states A1, A2, and A3 include respective pieces of specifying information for specifying the cross-fade, the slide-in, and the slide-out as the respective animation patterns.

In such a constitution, when the execution unit 19 executes the state transition (A1 to A2), the execution unit 19 acquires the animation pattern (cross-fade) specified by the specifying information included in the property of the display state A1 before the state transition from the state transition animation storage 18. Then, the execution unit 19 creates an animation display component to be executed on the way of the state transition (A1 to A2), on the basis of the acquired animation pattern (cross-fade).

Similarly, when the execution unit 19 executes the state transition (A2 to A3), the execution unit 19 acquires the animation pattern (slide-in) specified by the specifying information included in the property of the display state A2 before the state transition from the state transition animation storage 18. Then, the execution unit 19 creates an animation display component to be executed on the way of the state transition (A2 to A3), on the basis of the acquired animation pattern (slide-in).

Thus, the user interface apparatus 1 in accordance with the second variation creates an animation display component to be executed on the way of the state transition, on the basis of the animation pattern specific to each display state. Therefore, it is possible to achieve a display using the animation pattern suitable for each display state.

Further, when a state transition, even other than the state transition (A1 to A2), in which the display state before the state transition is the same as that before the state transition (A1 to A2) (for example, a state transition (A1 to A3) or the like) is executed, an animation display component may be created on the basis of the same animation pattern (cross-fade) as that for the state transition (A1 to A2).

Furthermore, in the above description, the execution unit 19 creates an animation display component on the basis of the animation pattern specified by the specifying information included in the property of the display state “before the state transition”. The present invention is not limited to this, but the execution unit 19 may create an animation display component on the basis of the animation pattern specified by the specifying information included in the property of the display state “after the state transition”.

When the execution unit 19 executes the state transition (A1 to A2), for example, the execution unit 19 may acquire the animation pattern (slide-in) specified by the specifying information included in the property of the display state A2 after the state transition and create an animation display component to be executed on the way of the state transition (A1 to A2) on the basis of the acquired animation pattern. Also in this case, like in the above-described case, it is possible to achieve a display using the animation pattern suitable for each display state.

<The Third Variation of the Second Preferred Embodiment>

FIG. 14 is a view showing an exemplary composite display component in accordance with a third variation of the second preferred embodiment. In the third variation, the property of each display component included in the state-specific display component (each display component shown on the right side of FIG. 4, such as the basic display component X1, the composite display component Y1, and the like) includes specifying information for specifying an animation pattern specific to the display component. FIG. 14 shows an exemplary case, and the properties of the basic display component X1, the composite display component Y1, the basic display component X2, and the composite display component Y2 include respective pieces of specifying information for specifying the cross-fade, the slide-in, the slide-out, and the slide-in as the respective animation patterns.

In such a constitution, when the execution unit 19 executes the state transition (A1 to A2), the execution unit 19 acquires the property of the basic display component X1 included in the state-specific display component before the state transition and further acquires the animation pattern (cross-fade) specified by the specifying information included in the property from the state transition animation storage 18. Then, the execution unit 19 creates an animation display component to be executed on the way of the state transition (A1 to A2), on the basis of the acquired animation pattern (cross-fade).

Similarly, when the execution unit 19 executes the state transition (A2 to A3), the execution unit 19 acquires the animation pattern (slide-in) specified by the specifying information included in the property of the composite display component Y1 included in the state-specific display component before the state transition, from the state transition animation storage 18. Then, the execution unit 19 creates an animation display component to be executed on the way of the state transition (A2 to A3), on the basis of the acquired animation pattern (slide-in).

Thus, the user interface apparatus 1 in accordance with the third variation creates an animation display component to be executed on the way of the state transition, on the basis of the animation pattern specific to each display component (the basic display component or the composite display component) included in the state-specific display component. Therefore, it is possible to achieve a display using the animation pattern suitable for each display component.

Further, when a display state, even other than the display state A1, which is defined by the same display component as that defining the display state A1 (for example, a display state defined by the basic display component X1 and the basic display component X2, or the like) is executed, an animation display component may be created on the basis of the same animation pattern (cross-fade) as that for the display state A1.

Furthermore, in the above description, the execution unit 19 creates an animation display component on the basis of the animation pattern specified by the specifying information included in the property of the display component included in the state-specific display component “before the state transition”. The present invention is not limited to this, but the execution unit 19 may create an animation display component on the basis of the animation pattern specified by the specifying information included in the property of the display component included in the state-specific display component “after the state transition”. Also in this case, like in the above-described case, it is possible to achieve a display using the animation pattern suitable for each display state.

Further, like in the display state A3 shown in FIG. 14, when the state-specific display component includes a plurality of display components and a plurality of animation patterns are acquired, the execution unit 19 may select one animation pattern on the basis of a priority which is pre-determined and create an animation display component on the basis of the selected one animation pattern. Alternatively, the execution unit 19 may create an animation display component by applying the above plurality of animation patterns to the display states defined by the plurality of display components, respectively. Specifically, the execution unit 19 may create an animation display component which enables a display of the state transition animation by the slide-out for a part of the display state A3, which is executed by the basic display component X2, and enables a display of the state transition animation by the slide-in for the other part of the display state A3, which is executed by the composite display component Y2.

Within the scope of the invention, the present invention allows free combination of the preferred embodiments, modification and variation of any constituent element of each of the preferred embodiments, or omission of any constituent element of each of the preferred embodiments.

### DESCRIPTION OF REFERENCE NUMERALS

1 user interface apparatus
11 input unit
12 display
16 state-specific display storage
17 event processing storage
18 state transition animation storage
19 execution unit

1. A user interface apparatus using a receiver and a display, comprising:
a state-specific display component storage which stores a state-specific display component for each display state, said state-specific display component including at least either one display component of a basic display component pre-designed as a component for screen display and a composite display component formed to include said basic display component;
an event processing storage which stores a state transition from a display state by one said state-specific display component to a display state by another said state-specific display component and an event processing, said state transition and said event processing being associated with each other; and
a processing circuitry which executes said event processing in accordance with an input operation received by said receiver and also executes, on said display, said state transition associated with said event processing to be executed,
wherein in a case of executing said state transition, said processing circuitry creates an animation display component which defines a display state by a state transition animation using said display state of said state-specific display component, and on the way of said state transition, executes said animation display component, to thereby display said state transition animation on said display; and
in a case of not executing said state transition, said processing circuitry displays said display state of said state-specific display components used by said state transition animation on said display.

2. The user interface apparatus according to claim 1, wherein
said processing circuitry creates said animation display component including said basic display components corresponding to said display states before and after said state transition.

3. The user interface apparatus according to claim 2, wherein
when said processing circuitry executes said animation display component and acquires an end event of said state transition animation, said processing circuitry displays said display state after said state transition on said display.

4. The user interface apparatus according to claim 1, further comprising:
a state transition animation storage which stores an animation pattern applicable to said animation display component,
wherein additional information of a plurality of state transitions include specifying information for specifying one said animation pattern common to said plurality of state transitions, and
in a case of executing each of said plurality of state transitions, said processing circuitry creates a plurality of said animation display components to be executed on the way of each of said plurality of state transitions, on the basis of said one animation pattern specified by said specifying information included in said additional information of said plurality of state transitions.

5. The user interface apparatus according to claim 1, further comprising:
a state transition animation storage which stores an animation pattern applicable to said animation display component,
wherein additional information of each said state transition includes specifying information for specifying said animation pattern specific to said state transition, and
in a case of executing said state transition, said processing circuitry creates said animation display component to be executed on the way of said state transition, on the basis of said animation pattern specified by said specifying information included in said additional information of said state transition.

6. The user interface apparatus according to claim 1, further comprising:
a state transition animation storage which stores an animation pattern applicable to said animation display component,
wherein additional information of each said display state includes specifying information for specifying said animation pattern specific to said display state, and
in a case of executing said state transition, said processing circuitry creates said animation display component to be executed on the way of said state transition, on the basis of said animation pattern specified by said specifying information included in said additional information of said display state before said state transition or after said state transition.

7. The user interface apparatus according to claim 1, further comprising:
a state transition animation storage which stores an animation pattern applicable to said animation display component,
wherein additional information of said at least either one display component included in said state-specific display component includes specifying information for specifying said animation pattern specific to said display component, and
in a case of executing said state transition, said processing circuitry creates said animation display component to be executed on the way of said state transition, on the basis of said animation pattern specified by said specifying information included in said additional information of said at least either one display component included in said state-specific display component before said state transition or after said state transition.

8. The user interface apparatus according to claim 2, wherein
said animation display component further includes said basic display component corresponding to a display state obtained by changing at least one of arrangement, shape, size, and color of a display state before said state transition or after said state transition.
